(19) United States
(12) Patent Application Publication
(10) Pub. No.: US 2024/0326560 A1
(43) Pub. Date: Oct. 3, 2024

(54) VEHICLE AIR CONDITIONING SYSTEM AND METHOD FOR REGENERATING AIR CONDITIONING DEVICE

(71) Applicant: NGK INSULATORS, LTD., Nagoya-Shi (JP)

(72) Inventor: Hirotaka SAITO, Komaki-Shi (JP)

(73) Assignee: NGK INSULATORS, LTD., Nagoya-Shi (JP)

(21) Appl. No.: 18/603,294

(22) Filed: Mar. 13, 2024

(30) Foreign Application Priority Data
Mar. 29, 2023 (JP) 2023-054070

(51) Int. Cl. B60H 1/22

(52) U.S. Cl. CPC B60H 1/2225; B60H 1/2218

(57) ABSTRACT

A vehicle air conditioning system includes: an air conditioning duct through which air can flow; an air conditioning device disposed in the air conditioning duct; and a control unit for controlling the air conditioning device. The air conditioning device includes: a honeycomb structure including an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a functional material-containing layer formed on a surface of each of the partition walls.

### CROSS REFERENCE TO RELATED APPLICATIONS

The present invention claims the benefit of priority to Japanese Patent Application No 2023-054070 filed on Mar. 29, 2023 with the Japanese Patent Office, the entire contents of which are incorporated herein by reference in its entirety.

### FIELD OF THE INVENTION

The present invention relates to a vehicle air conditioning system, and a method for regenerating an air conditioning device.

### BACKGROUND OF THE INVENTION

In various types of vehicles such as automobiles, there are increasing requirements for improvement of vehicle interior environment. Specific requirements include reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problem, an air conditioning system for vehicles is known in which components to be removed such as CO₂ and water vapor in the air in the vehicle interior are trapped by a functional material such as an adsorbent, and the components to be removed are then allowed to react or desorbed by heating to discharge them to the outside of the vehicle and regenerate the functional material.

For example, Patent Literature 1 discloses a system for controlling an atmosphere in a passenger cabin (vehicle interior) of a vehicle, which is provided with a CO₂ removal assembly including a renewable CO₂ sorbent, a CO₂ removal conduit, and a regeneration conduit. In this system, air from the inside of the passenger cabin (inside air) is allowed to flow over the renewable CO₂ sorbent, the treated air is returned to the passenger cabin via the CO₂ removal conduit, and the desorbed gas heated by a heater is allowed to flow over the regenerable CO₂ sorbent to desorbed CO₂ from the CO₂ sorbent, and the desorbed CO₂ is discharged through a regeneration conduit at a location outside the passenger cabin.

However, in this system, even if the state of desorbing CO₂ is switched to the state of adsorbing CO₂, the state of desorbing CO₂ will continue for a while, so that even after the state of desorbing CO₂ is finished, the CO₂ sorbent continues to be at a temperature higher than the predetermined temperature, causing a problem that the desorbed substances to be purified are returned to the vehicle interior.

Therefore, to solve the problem, Patent Literature 2 discloses a system having two flow paths (a first flow path and a second flow path) that communicate with the vehicle interior of the vehicle, wherein adsorption blocks for adsorbing components to be removed are arranged, and each flow path includes: a flow path for returning the air from which the components to be removed have been removed to the vehicle interior of the vehicle; and a flow path for exhausting the air from which the components to be removed from the adsorption blocks to the outside of the vehicle interior. In this system, each component is controlled at a timing that can control the flow of the air from the side where the component to be purified is desorbed, of the first flow path and the second flow path, to the vehicle interior, so that the operation for returning the air that has adsorbed and purified the components to be purified by one of the adsorption blocks to the vehicle interior of the vehicle, and the operation for exhausting the air from which the components to be purified have been desorbed by the other adsorption block to the outside of the vehicle interior can be achieved at the same time, and the flow of unpurified air to the vehicle interior can be suppressed.

In the conventional system as described above, the regeneration of the adsorbent (the desorption of components to be purified) is carried out by using air heated by the heating device such as a heater. However, when such a heating device is used, it will take a long period of time to regenerate the adsorbent and the size of the system will be increased.

Therefore, it is conceivable to use a heater element capable of self-heating as a support for a functional material that adsorbs the components to be removed such as CO₂. For example, Patent Literature 3 discloses a heater element, including: a pillar shaped honeycomb structure having an outer peripheral wall and partition walls disposed on an inner side of the outer peripheral wall and defining a plurality of cells forming flow paths from a first end face to a second end face, wherein the partition walls have a PTC property, the partition walls have an average thickness of 0.13 mm or less, and the first end face and the second end face have an opening ratio of 0.81 or more. This heater element is used for heating a vehicle interior, and is an efficient heating means because the honeycomb structure allows the heating area to be increased. Therefore, the use of such a heater element as a support for the functional material can contribute to the shortening of the regeneration time of the functional material. In particular, it is believed that since this heater element can be heated by electric conduction and has a PTC property, it can easily heat the functional material, while suppressing excessive heat generation and thermal deterioration of the functional material. Further, since the risk of excessive temperature is avoided, safety can be ensured even if small initial resistance is set to increase a heating rate, and the temperature can be increased in a short period of time.

When a heater element is used as a support for a functional material, the functional material is regenerated by the electrical conduction of the heater element for a predetermined period of time, but the electrical conduction may be continued even after it reaches the regeneration temperature of the functional material. That is, excessive power may be used to regenerate the functional material, resulting in wasted power consumption.

The present invention was made to solve the problems as described above. An object of the present invention is to provide a vehicle air conditioning system that can reduce power consumption by inputting optimal power when regenerating a functional material (a layer containing a functional material), and a method for regenerating an air conditioning device.

### PRIOR ART

### Patent Literatures

[Patent Literature 1] Japanese Patent Application Publication No. 2017-528316 A
[Patent Literature 2] Japanese Patent Application Publication No. 2020-104774 A
[Patent Literature 3] WO 2020/036067 A1

### SUMMARY OF THE INVENTION

As a result of extensive studies for an air conditioning system for vehicles, which is provided with an air conditioning device including: a predetermined honeycomb structure; a pair of electrodes provided on the predetermined honeycomb structure; and a functional material-containing layer formed on surfaces of partition walls of the predetermined honeycomb structure, the present inventors have found that the above problems can be solved by heating the honeycomb structure to regenerate the functional material-containing layer and stopping voltage application to the pair of electrodes at a stage of reaching a Curie point of the honeycomb structure, and they have completed the present invention. That is, the present invention is illustrated as follows:

[1]

A vehicle air conditioning system, comprising:
an air conditioning duct through which air can flow;
an air conditioning device disposed in the air conditioning duct; and
a control unit for controlling the air conditioning device,
wherein the air conditioning device comprises: a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a functional material-containing layer formed on a surface of each of the partition walls, and wherein the control unit executes a voltage application to the pair of electrodes to heat the honeycomb structure and regenerate the functional material-containing layer, and stops the voltage application to the pair of electrodes at a stage of reaching the Curie point of the honeycomb structure.
   [2]

The vehicle air conditioning system according to [1], wherein the control unit determines the stage of reaching the Curie point of the honeycomb structure by calculating a resistance ratio of a resistance over time during the voltage application to an initial resistance of the honeycomb structure.

[3]

The vehicle air conditioning system according to [2], wherein the control unit calculates an amount of variation in the resistance ratio per a predetermined time, checks a maximum value of the amount of variation, and then stops the voltage application to the pair of electrodes at the stage where the amount of variation becomes ⅔ or less of the maximum value of the amount of variation.

[4]

The vehicle air conditioning system according to [3], wherein the amount of variation at which the voltage application is stopped is less than or equal to ½ of the maximum value of the amount of variation.

[5]

The vehicle air conditioning system according to [3] or [4], wherein the predetermined time is 5 to 25 seconds.

[6]

The vehicle air conditioning system according to any one of [1] to [5], wherein the air conditioning device further comprises terminals connected to the pair of electrodes.

[7]

The vehicle air conditioning system according to any one of [1] to [6], wherein the material having the PTC property is made of a material comprising barium titanate as a main component, the material being substantially free of lead.

[8]

The vehicle air conditioning system according to any one of [1] to [7], wherein the material having the PTC property has a volume resistivity of 0.5 to 30 Ω·cm at 25° C.

[9]

The vehicle air conditioning system according to any one of [1] to [8], wherein the honeycomb structure has a thickness of the partition wall of 0.300 mm or less, a cell density of 100 cells/cm² or less, and a cell pitch of 1.0 mm or more.

[10]

The vehicle air conditioning system according to any one of [1] to [8], wherein the honeycomb structure has a thickness of the partition wall of 0.08 to 0.36 mm, a cell density of 2.54 to 140 cells/cm², and an opening ratio of the cells of 0.70 or more.

[11]

The vehicle air conditioning system according to any one of [1] to [10], wherein the functional material-containing layer comprises a functional material having a function of adsorbing one or more selected from water vapor, carbon dioxide, and volatile components.

[12]

The vehicle air conditioning system according to [11], wherein the functional material-containing layer comprises a catalyst.

[13]

A method for regeneration of an air conditioning device, the air conditioning device comprising: a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a functional material-containing layer formed on a surface of each of the partition walls,
wherein the method comprises executing a voltage application to the pair of electrodes to heat the honeycomb structure and to regenerate the functional material-containing layer, and stopping the voltage application to the pair of electrodes at a state of reaching a Curie point of the honeycomb structure.
   [14]

The method for regenerating an air conditioning device according to [13], wherein the stage of reaching the Curie point of the honeycomb structure is determined by calculating a resistance ratio of a resistance over time during the voltage application to an initial resistance of the honeycomb structure.

[15]

The method for regenerating an air conditioning device according to [14], wherein an amount of variation in the resistance ratio per a predetermined time is calculated, a maximum value of the amount of variation is checked, and then the voltage application to the pair of electrodes is stopped at a stage where the amount of variation becomes ⅔ or less of the maximum value of the amount of variation.

[16]

The method for regenerating an air conditioning device according to [15], wherein the amount of variation at which the voltage application is stopped is less than or equal to ½ of the maximum value of the amount of variation.

[17]

The method for regenerating an air conditioning device according to or [16], wherein the predetermined time is 5 to 25 seconds.

The method for regenerating an air conditioning device according to any one of to [17], wherein the air conditioning device further comprises terminals connected to the pair of electrodes.

### BRIEF DESCRIPTION OF THE DRAWINGS

FIG. 1 is an overall schematic configuration view of a vehicle air conditioning system according to an embodiment of the present invention;

FIG. 2A is a schematic view of a cross section parallel to a flow path direction of an air conditioning device used for a vehicle air conditioning system and a method for regenerating an air conditioning device according to an embodiment of the present invention;

FIG. 2B is a schematic cross-sectional view of the air conditioning device in FIG. 2A taken along the line a-a′; and

FIG. 3 is a graph showing a relationship between a voltage application time to a honeycomb structure and a resistance ratio at each predetermined time.

### DETAILED DESCRIPTION OF THE INVENTION

The vehicle air conditioning system according to an embodiment of the present invention includes: an air conditioning duct through which air can flow; an air conditioning device disposed in the air conditioning duct; and a control unit for controlling the air conditioning device, wherein the air conditioning device incudes: a honeycomb structure including an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a functional material-containing layer formed on a surface of each of the partition walls, and wherein the control unit executes a voltage application to the pair of electrodes to heat the honeycomb structure and to regenerate the functional material-containing layer, and stops the voltage application to the pair of electrodes at a stage of reaching a Curie point of the honeycomb structure. With such a structure, the vehicle air conditioning system according to the embodiment of the present invention promptly stops the voltage application after reaching the regeneration temperature of the functional material-containing layer, so that any excessive input of electricity can be suppressed for regeneration of the functional material-containing layer. Therefore, it is possible to input the optimum power when regenerating the functional material-containing layer and to suppress power consumption.

The method for regeneration of an air conditioning device according to an embodiment of the present invention, the air conditioning device includes: a honeycomb structure including an outer peripheral wall and a partition wall disposed on an inner side of the outer peripheral wall, the partition wall defining a plurality of cells, each of the cells extending from a first end face to a second end face to form a flow path, at least the partition walls being made of a material having a PTC property; a pair of electrodes provided on the honeycomb structure; and a functional material-containing layer formed on the surface of the partition wall, wherein the method includes executing a voltage application to the pair of electrodes to heat the honeycomb structure and regenerating the functional material-containing layer, and stopping the voltage application to the pair of electrodes at a state of reaching the Curie point of the honeycomb structure. With such a configuration, the method for regenerating an air conditioning device according to the embodiment of the present invention promptly stops the voltage application after reaching the regeneration temperature of the functional material-containing layer, so that any excessive input of electricity can be suppressed for regeneration of the functional material-containing layer. Therefore, it is possible to input the optimum power when regenerating the functional material-containing layer and to suppress power consumption.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### <Vehicle Air Conditioning System>

The vehicle air conditioning system according to an embodiment of the present invention can be suitably utilized as a vehicle air conditioning system in a vehicle. The vehicle includes, but not limited to, automobiles and trains. Non-limiting examples of the automobile include gasoline vehicles, diesel vehicles, gas fuel vehicles using CNG (a compressed natural gas) or LNG (a liquefied natural gas), fuel cell vehicles, plug-in hybrid vehicles and electric vehicles. Among them, the air conditioning system according to the embodiment of the present invention can be suitably used in electric vehicles for which reduction of power consumption is particularly required.

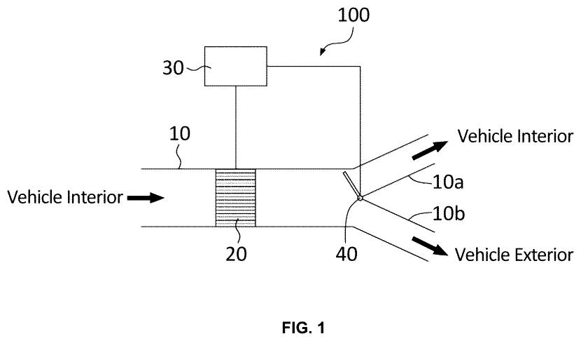

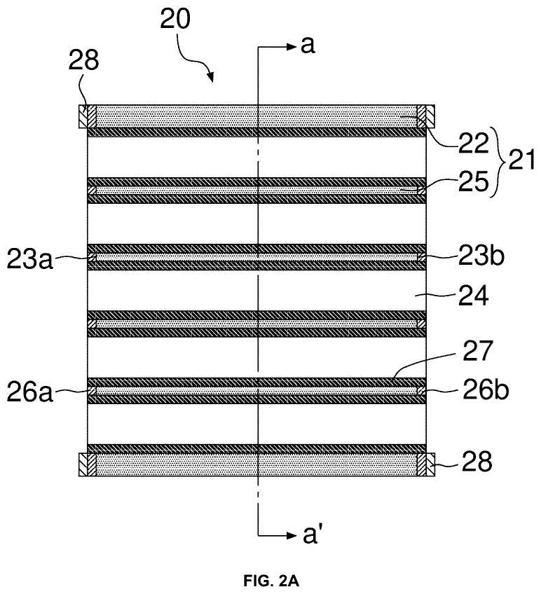

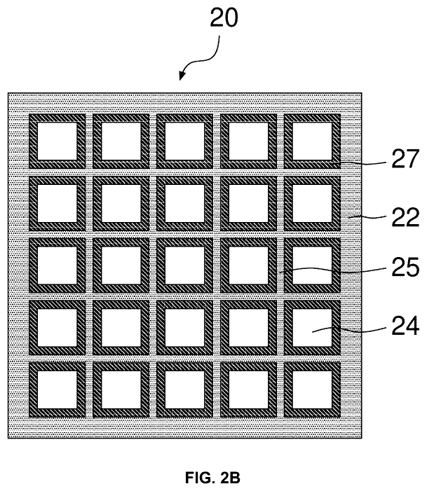

FIG. 1 is an overall schematic configuration view of a vehicle air conditioning system according to an embodiment of the present invention. FIG. 2A is a schematic view of a cross section parallel to a flow path direction of an air conditioning device used for a vehicle air conditioning system according to an embodiment of the present invention. FIG. 2B is a schematic cross-sectional view of the air conditioning device in FIG. 2A taken along the line a-a′.

As shown in FIG. 1, a vehicle air conditioning system 100 according to an embodiment of the present invention includes: an air conditioning duct 10 through which air can flow; an air conditioning device 20 disposed in the air conditioning duct 10; and a control unit 30 for controlling the air conditioning device 20.

As shown in FIGS. 2A and 2B, the air conditioning device 20 includes: a honeycomb structure 21 having an outer peripheral wall 22 and partition walls 25 disposed on an inner side of the outer peripheral wall 22 and defining a plurality of cells 24, each extending from a first end face 23a to a second end face 23b to form a flow path, at least the partition walls 25 being made of a material having a PTC property; a pair of electrodes 26a, 26b provided on the first end face 23a and the second end face 23b; and a functional material-containing layer 27 formed on a surface of each of the partition walls 25.

In the vehicle air conditioning system 100 having the above structure, air from the vehicle interior flows into the air conditioning device 20 through the air conditioning duct 10, and components to be removed are captured (removed) by the functional material containing layer 27 while the air passes through the air conditioning device 20. The air from which the components to be removed have been removed is then returned to the vehicle interior. Since the performance of the functional material-containing layer 27 gradually decreases as captured amounts of the components to be removed increases, the functional material-containing layer 27 should be regenerated. The functional material-containing layer 27 is regenerated by applying voltage to the pair of electrodes 26a, 26b of the air conditioning device 20 and heating the honeycomb structure 21. Since the functional material-containing layer 27 is also heated by the heating of the honeycomb structure 21, the components to be removed that are captured in the functional material-containing layer 27 are desorbed from the functional material-containing layer 27 or reacted and released, and are discharged to the vehicle exterior.

The regeneration of the functional material-containing layer 27 is executed by the control unit 30. The control unit 30 stops the voltage application to the pair of electrodes 26a, 26b at the state of reaching the Curie point of the honeycomb structure 21. The material having the PTC property has the characteristics that when the temperature increases to exceed the Curie point, the resistance value rapidly increases, resulting in difficulty for electricity to flow. Therefore, by stopping the voltage application at the above stage, it is possible to suppress input of excessive power for regenerating the functional material-containing layer 27. Furthermore, since any excessive heat generation in the functional material-containing layer 27 is suppressed, any thermal deterioration of the functional material-containing layer 27 can also be suppressed.

Preferably, the control unit 30 determines the stage of reaching the Curie point of the honeycomb structure 21 by calculating a resistance ratio of a resistance over time during the voltage application to an initial resistance of the honeycomb structure 21. By thus determining the stage of reaching the Curie point of the honeycomb structure 21, it is not necessary to determine the Curie point of the honeycomb structure 21 in advance and then continuously measure the temperature of the honeycomb structure 21. Therefore, the voltage application state can be easily controlled by the control unit 30.

It should be noted that the initial resistance and the resistance over time can be calculated from the magnitude of the current and voltage flowing through the honeycomb structure 21.

It is preferable that the control unit 30 calculates an amount of variation in the resistance ratio per a predetermined time (hereinafter referred to as “resistance ratio variation amount”), checks the maximum value of the resistance ratio variation amount, and then stops the voltage application to the pair of electrodes 26a, 26b at the time when the resistance ratio variation amount becomes ½ or less of the maximum value of the resistance ratio variation amount. The resistance ratio variation amount per a predetermined time can be obtained by measuring the resistance at the start and end points of the predetermined time, calculating each resistance ratio of the resistance to the initial resistance, and then determining a difference between the resistance ratio at the start point of the predetermined time and the resistance ratio at the end point of the predetermined time.

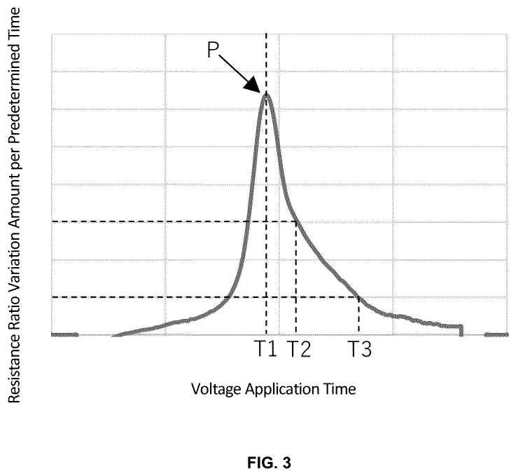

Here, FIG. 3 shows a graph showing a relationship between a time during which a voltage is applied to the honeycomb structure 21 (voltage application time) and a resistance ratio variation amount per a predetermined time.

As shown in FIG. 3, the resistance ratio variation amount per a predetermined time increases with passage of the voltage application time, and reaches the maximum value P at a voltage application time T1. The resistance ratio variation amount gradually decreases as the voltage application time passes.

Since the material having the PTC property has the characteristic that when the temperature increases to exceed the Curie point, the resistance value rapidly increases, resulting in difficulty for electricity to flow, it is believed that the vicinity of the maximum value P of the resistance ratio variation amount is the Curie point of the honeycomb structure 21. Therefore, it can be estimated that the stage at which the resistance ratio variation exceeds the maximum value P (the stage at which the voltage application time exceeds T1) is the stage of reaching the Curie point of the honeycomb structure 21. However, immediately after the maximum value P of the resistance ratio fluctuation amount is exceeded, there is a risk that the Curie point of the honeycomb structure 21 has not yet been reached. Therefore, after exceeding the maximum value P of the resistance ratio variation amount, the stage at which the resistance ratio variation amount becomes ⅔ or less of the maximum value P of the resistance ratio variation amount (the stage at which the voltage application time exceeds T2) is preferably the stage of reaching the Curie point of the honeycomb structure 21. Here, the stage at which the resistance ratio variation amount becomes ⅔ or less of the maximum value P of the resistance ratio variation amount means a time when the resistance ratio variation amount becomes any value in the range of ⅔ or less (e.g., ⅔, ½, ⅓, ¼, and the like) of the maximum value P of the resistance ratio variation amount. In a typical embodiment, the maximum value P of the resistance ratio variation amount is about 0.6, so that the stage at which the resistance ratio variation amount becomes about 0.4 may be considered to be the stage of reaching the Curie point of the honeycomb structure 21.

It is more preferable that the resistance ratio variation amount at which the voltage application is stopped is ½ or less of the maximum value P of the resistance ratio variation amount. At this stage (the stage at which the voltage application time exceeds T3), it can be said that the Curie point of the honeycomb structure 21 has definitely been reached. As used herein, the stage at which the resistance ratio variation amount becomes ½ or less of the maximum value P of the resistance ratio variation amount means a time when the resistance ratio variation amount becomes any value in the range of ½ or less (e.g., ½, ⅓, ¼, ⅕, and the like) of the maximum value P of the resistance ratio variation amount.

It should be noted that the lower limit of the resistance ratio at which voltage application is stopped is not particularly limited, but it is, for example, ⅕.

The predetermined time for calculating the resistance ratio variation amount is not particularly limited, but it is preferably 5 to 25 seconds. Such a range can allow the amount of variation in the resistance ratio to be ensured while minimizing the frequency of resistance measurement.

Each component of the vehicle air conditioning system 100 will be described below in detail.

### (1. Air Conditioning Duct 10)

The air conditioning duct 10 is a flow path through which air can flow. The air conditioning duct 10 allows the air from the vehicle interior to flow in, and also allows the air that has passed through the air conditioning device 20 to flow in the vehicle interior or discharge it to the vehicle exterior. Therefore, it is preferable that the air conditioning duct 10 is branched on a downstream side of the air conditioning device 20 into a first path 10a that flows in the vehicle interior and a second path 10b that discharges the fluid to the vehicle exterior.

The air conditioning duct 10 may include a switching valve 40 that can switch the flow of the air between the first path 10a and the second path 10b. The switching valve 40 is not particularly limited as long as it is electrically driven and has the function of switching the flow path, and a solenoid valve, an electric valve, and the like can be used. For example, the switching valve 40 includes an opening/closing door supported by a rotating shaft and an actuator such as a motor that rotates the rotating shaft. The actuator can be configured to be controllable by the control unit 30.

Additionally, a ventilator (not shown) can be provided in the air conditioning duct 10 for causing the air from the vehicle interior to flow in the air conditioning device 20. Although the position of the ventilator is not particularly limited, it can be provided on an upstream side of the air conditioning device 20, for example.

### (2. Air Conditioning Device 20)

As shown in FIGS. 2A and 2B, the air conditioning device 20 includes: a honeycomb structure 21 having an outer peripheral wall 22 and partition walls 25 disposed on an inner side of the outer peripheral wall 22, the partition walls 25 defining a plurality of cells 24 each extending from a first end face 23a to a second end face 23b to form a flow path; a pair of electrodes 26a, 26b provided on the honeycomb structure 21; and a functional material-containing layer 27 formed on a surface of each of the partition walls 25. The air conditioning device 20 may further include terminals 28 connected to the pair of electrodes 26a, 26b. The providing of the terminals 28 facilitates connection to a conducting wire connected to an external power source.

### (2-1. Honeycomb Structure 21)

The shape of the honeycomb structure 21 is not particularly limited. For example, an outer shape of a cross section of the honeycomb structure 21 orthogonal to the flow path direction (the extending direction of the cells 24) can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 23a and second end face 23b) have the same shape as the cross section. Also, when the cross section and the end faces are polygonal, the corners may be chamfered.

The shape of each cell 24 is not particularly limited, but it may be polygonal such as quadrangular, pentagonal, hexagonal, heptagonal, and octagonal, circular, or oval in the cross section of the honeycomb structure 21 orthogonal to the flow path direction. These shapes may be alone or in combination of two or more. Moreover, among these shapes, the quadrangle or the hexagon is preferable. By providing the cells 24 having such a shape, it is possible to reduce the pressure loss when the air flows.

The honeycomb structure 21 may be a honeycomb joined body having a plurality of honeycomb segments and joining layers that join outer peripheral side surfaces of the plurality of honeycomb segments together. The use of the honeycomb joined body can increase the total cross-sectional area of the cells 24, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having the PTC property, or may contain the same material as the outer peripheral wall 22 and the partition walls 25. In addition to the role of joining the honeycomb segments to each other, the joining material can also be used as an outer peripheral coating material after joining the honeycomb segments.

From the viewpoints of ensuring the strength of the honeycomb structure 21, reducing pressure loss when air passes through the cells 24, ensuring the amount of functional material supported, and ensuring the contact area with the air flowing inside the cells 24, it is desirable to suitably combine a thickness of the partition wall 25, a cell density, and a cell pitch (or an opening ratio of the cells).

As used herein, the cell density refers a value obtained by dividing a number of cells by an area of one end face (first end face 23a or second end face 23b) of the honeycomb structure 21 (the total area of the partition walls 25 and the cells 24 excluding the outer peripheral wall 22).

As used herein, the cell pitch refers to a value obtained by the following calculation. First, the area of one end face (first end face 23a or second end face 23b) of the honeycomb structure 21 (the total area of the partition walls 25 and the cells 24 excluding the outer peripheral wall 22) is divided by the number of the cells to calculate an area per a cell. A square root of the area per a cell is then calculated, and this is determined to be the cell pitch.

As used herein, the opening ratio of the cells 24 refers a value obtained by dividing the total area of the cells 24 defined by the partition walls 25 by the area of one end face (first end face 23a or second end face 23b) (the total area of the partition walls 25 and the cells 24 excluding the outer peripheral wall 22) in the cross section orthogonal to the flow path direction of the honeycomb structure 21. It should be noted that when calculating the opening ratio of the cells 24, the pair of electrodes 26a, 26b, and the functional material-containing layer 27 are not taken into account.

In an embodiment that is advantageous from the viewpoint of supporting a sufficient amount of functional material, the thickness of the partition wall 25 is 0.300 mm or less, the cell density is 100 cells/cm² or less, and the cell pitch is 1.0 mm or more. In a preferred embodiment, the thickness of the partition wall 25 is 0.200 mm or less, the cell density is 70 cells/cm² or less, and the cell pitch is 1.2 mm or more. In a more preferred embodiment, the thickness of the partition wall is 0.130 mm or less, the cell density is 65 cells/cm² or less, and the cell pitch is 1.3 mm or more.

From the viewpoints of ensuring the strength of the honeycomb structure 21 and maintaining lower electrical resistance, the lower limit of the thickness of the partition wall 25 is preferably 0.010 mm or more, and more preferably 0.020 mm or more, and even more preferably 0.030 mm or more.

From the viewpoints of ensuring the strength of the honeycomb structure 21, maintaining lower electrical resistance, and increasing a surface area to facilitate reaction, adsorption, and release, the lower limit of the cell density is 30 cells/cm² or more, and preferably 35 cells/cm² or more, and even more preferably 40 cells/cm² or more.

From the viewpoints of ensuring the strength of the honeycomb structure 21, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition wall 25 is 0.08 to 0.36 mm, the cell density is 2.54 to 140 cells/cm², and the opening ratio of the cells 24 is 0.70 or more. In a preferred embodiment, the thickness of the partition wall 25 is 0.09 to 0.35 mm, the cell density is 15 to 100 cells/cm², and the opening ratio of the cells 24 is 0.80 or more. In a more preferred embodiment, the thickness of the partition wall 25 is 0.14 to 0.30 mm, the cell density is 20 to 90 cells/cm², and the opening ratio of the cells 24 is 0.85 or more.

From the viewpoint of ensuring the strength of the honeycomb structure 21, the upper limit of the opening ratio of the cells 24 is preferably 0.94 or less, and more preferably 0.92 or less, and even more preferably 0.90 or less.

Although the thickness of the outer peripheral wall 22 is not particularly limited, it is preferably determined based on the following viewpoints. First, from the viewpoint of reinforcing the honeycomb structure 21, the thickness of the outer peripheral wall 22 is preferably 0.05 mm or more, and more preferably 0.06 mm or more, and even more preferably 0.08 mm or more. On the other hand, the thickness of the outer peripheral wall 22 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

As used herein, the thickness of the outer peripheral wall 22 refers to a length from a boundary between the outer peripheral wall 22 and the outermost cell 24 or the partition wall 25 to a side surface of the honeycomb structure 21 in a normal line direction of the side surface in the cross section orthogonal to the flow path direction.

The length of the honeycomb structure 21 in the flow path direction and the cross-sectional area orthogonal to the flow path direction may be adjusted according to the required size of the air conditioning device 20, and are not particularly limited. For example, when used in a compact air conditioning device 20 while ensuring a predetermined function, the honeycomb structure 21 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less

The partition walls 25 forming the honeycomb structure 21 are made of a material that can be heated by electric conduction, specifically made of a material having the PTC (Positive Temperature Coefficient) property. Further, the outer peripheral wall 22 may also be made of the material having the PTC property, as with the partition walls 25, as needed. By such a configuration, the functional material-containing layer 27 can be heated by heat transfer from the heat-generating partition walls 25 (and optionally the outer peripheral wall 22). Further, the material having the PTC property has characteristics such that when the temperature increases to exceed the Curie point, the resistance value is sharply increased, resulting in a difficult for electricity to flow. Therefore, when the temperature of the partition walls 25 (and the outer peripheral wall 22 if necessary) becomes high, the current flowing through them is limited, thereby suppressing excessive heat generation of the honeycomb structure 21. Therefore, it is possible to suppress thermal deterioration of the functional material-containing layer 27 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271:2008.

From the viewpoints that can be heated by electric conduction and has the PTC property, the outer peripheral wall 22 and the partition walls 25 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤ x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer peripheral wall 22 and the partition walls 25 are substantially free of lead (Pb). More particularly, the outer peripheral wall 22 and the partition walls 25 preferably have a Pb content of 0.01% by mass or less, and more preferably 0.001% by mass or less, and still more preferably 0% by mass. The lower Pb content can allow the air heated by contact with the heat-generating partition walls 25 to be safely applied to organisms such as humans, for example. In the outer peripheral wall 22 and the partition walls 25, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material making up the outer peripheral wall 22 and the partition walls 25 preferably have a lower limit of a Curie point of 100° C. or more, and more preferably 110° C. or more, and even more preferably 125° C. or more, in terms of efficiently heating the functional material-containing layer 27. Further, the upper limit of the Curie point is preferably 250° C. or more, and preferably 225° C. or more, and even more preferably 200° C. or more, and still more preferably 150° C. or more, in terms of safety as a component placed in the vehicle interior or near the vehicle interior.

The Curie point of the material making up the outer peripheral wall 22 and the partition walls 25 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. A Pair of Electrodes 26a, 26b)

A pair of electrodes 26a, 26b may be provided on the first end face 23a and the second end face 23b, although the positions of the electrodes 26a, 26b are not limited thereto. Also, the pair of electrodes 26a, 26b may be provided on a pair of outer peripheral walls 22 parallel to the extending direction of the cells 24.

Applying of a voltage between the pair of electrodes 26a, 26b allows the honeycomb structure 21 to generate heat by Joule heat.

The pair of electrodes 26a, 26b may employ, for example, a metal or alloy containing at least one selected from Cu, Ag, Al, Ni and Si, although not particularly limited thereto. It is also possible to use an ohmic electrode capable of ohmic contact with the outer peripheral wall 22 and/or the partition walls 25 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 26a, 26b may have a single-layer structure, or may have a laminated structure of two or more layers. When the pair of electrodes 26a, 26b have the laminated structure of two or more layers, the materials of the respective layers may be of the same type or of different types.

The thickness of the pair of electrodes 26a, 26b may be appropriately set according to the method for forming the pair of electrodes 26a, 26b. The method for forming the pair of electrodes 26a, 26b includes metal deposition methods such as sputtering, vapor deposition, electrolytic deposition, and chemical deposition. Alternatively, the pair of electrodes 26a, 26b can be formed by applying an electrode paste and then baking it, or by thermal spraying. Furthermore, the pair of electrodes 26a, 26b may be formed by joining metal sheets or alloy sheets.

Each of the thicknesses of the pair of electrodes 26a, 26b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

### (2-3. Terminal 28)

The terminals 28 are provided on at least a part of the pair of electrodes 26a, 26b. The provision of the terminals 28 facilitates connection to an external power supply. The terminals 28 are connected to a conductor connected to the external power supply.

The terminals 28 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 28 are not particularly limited. For example, as shown in FIG. 2A, the terminals 28 can be provided on the whole of the pair of electrodes 26a, 26b on the outer peripheral wall 22. Further, the terminals 28 may be provided on a part of the pair of electrodes 26a, 26b on the outer peripheral wall 22, or may be provided so as to extend toward an outer side than the outer edge of each of the pair of electrodes 26a, 26b on the outer peripheral wall 22. Further, the terminals 28 may be provided on a part of the pair of electrodes 26a, 26b on the partition walls 25, or may be provided so as to block a part of the cells 24.

Furthermore, the thickness of the terminal 28 is not particularly limited, but it is, for example, 0.01 to 10 mm, typically 0.05 to 5 mm.

The method of connecting the terminals 28 to the pair of electrodes 26a, 26b is not particularly limited as long as they are electrically connected. For example, they can be connected by diffusion bonding, a mechanical pressing mechanism, welding, or the like.

In the air conditioning device 20, the volume resistivity [0 cm] of the pair of electrodes 26a, 26b is ρ1, the thickness [mm] of the pair of electrodes 26a, 26b is t1, the volume resistivity [0 cm] of the partition walls 25 is ρ2, the thickness [mm] of the partition wall 25 is t2, the volume resistivity [Ω·cm] of the terminals 28 is ρ3, and the thickness [mm] of the terminal 28 is t3.

In this case, in the air conditioning device 20, (ρ1/t1)/(ρ2/t2) is 0.003 or less. By controlling the value of (ρ1/t1)/(ρ2/t2) in such a range, the electrical resistance of the pair of electrodes 26a, 26b is sufficiently lower than that of the base material (partition walls 25) of the honeycomb structure 21. As a result, the current from the pair of electrodes 26a, 26b tends to spread uniformly to the partition walls 25, so that the deviation of the current can be suppressed and the temperature distribution in the air conditioning device 20 can be made uniform. From the viewpoint of stably ensuring this effect, the (ρ1/t1)/(ρ2/t2) is preferably 0.001 or less, and more preferably 0.0001 or less. Although the lower limit is not particularly limited because a lower value of (ρ1/t1)/(ρ2/t2) tends to obtain the above effect, it is, for example, 0.0000001.

Further, in the air conditioning device 20, the (ρ1/t1)/(ρ3/t3) is 0.02 or more. By controlling the value of (ρ1/t1)/(ρ3/t3) in such a range, the current from the terminals 28 tends to spread uniformly to the pair of electrodes 26a, 26b. As a result, the current also tends to spread uniformly from the pair of electrodes 26a, 26b to the partition walls 25, so that the deviation of the current can be suppressed and the temperature distribution in the air conditioning device 20 can be made uniform. It should be noted that if the (ρ1/t1)/(ρ3/t3) is less than 0.02, the current will flow through a part of the pair of electrodes 26a, 26b before spreading the current in the terminals, resulting in the deviation of the current. From the viewpoint of stably ensuring the above effects, the (ρ1/t1)/(ρ3/t3) is preferably 1 or more, and more preferably 10 or more. Although the upper limit is not particularly limited because a larger value of (ρ1/t1)/(ρ3/t3) tends to obtain the above effect, it is, for example, 5000.

As used herein, the thickness of the pair of electrodes 26a, 26b refers to an average value of the thicknesses of all the electrodes 26a, 26b. Further, the thickness of the partition wall 25 refers to a length of a line segment across the partition wall 25 when the centers of gravity of adjacent cells 24 are connected by the line segment in a cross section orthogonal to the flow path direction. The thickness of the partition wall 25 refers to an average value of the thicknesses of all the partition walls 25. Furthermore, the thickness of the terminal 28 refers to an average value of the thicknesses of all the terminals 28.

The thicknesses of the pair of electrodes 26a, 26b and the terminal 28 can be measured in the cross section parallel to the flow path direction. Alternatively, the thicknesses of the materials used for the pair of electrodes 26a, 26b and the terminals 28 may be the thicknesses of the pair of electrodes 26a, 26b and the terminal 28. Also, the thickness of the partition wall 25 can be measured in the cross section orthogonal to the flow path direction.

The volume resistivity of each of the pair of electrodes 26a, 26b, the partition walls 25, and the terminals 28 refers to a volume resistivity at 25° C. The volume resistivity at 25° C. is measured according to JIS K 6271:2008.

In the air conditioning device 20, the area [mm²] of the surfaces where the terminals 28 are in contact with the pair of electrodes 26a, 26b is S1, and the area [mm²] of the first end face 23a or second end face 23b of the honeycomb structure 21 is S2.

In this case, it is preferable that the air conditioning device 20 has S1/S2 of 0.010 or more. By controlling the value of S1/S2 in such a range, it is possible to increase the area of the region where the current flows from the terminals 28 to the honeycomb structure 21 (electric conduction area), thereby suppressing the deviation of the current and easily making the temperature distribution in the element 1 uniform. From the viewpoint of stably ensuring this effect, the S1/S2 is more preferably 0.050 or more, and even more preferably 0.150 or more. On the other hand, a lager S1/S2 results in a smaller area of the region (cells 24) through which the air flows. Therefore, the S1/S2 is preferably 0.430 or less, and more preferably 0.300 or less, and even more preferably 0.250 or less.

As used herein, the area of the first end face 23a or the second end face 23b of the honeycomb structure 21 refers to an area of the first end face 23a or the second end face 23b composed of the outer peripheral wall 22, the cells 24, and the partition walls 25.

Optionally, the air conditioning device 20 may further include an intermediate member between the pair of electrodes 26a, 26b and the terminals 28.

In the air conditioning device 20, the area [mm²] of the surfaces where the terminals 28 are in contact with the intermediate material is S3, and the area [mm²] of the surface where the intermediate material is in contact with the pair of electrodes 26a, 26b is S4.

In this case, the air conditioning device 20 preferably has S4/S3 of 0.50 to 2.00. By controlling the value of S4/S3 in such a range, it is possible to smooth the flow of current between the pair of electrodes 26a, 26b and the terminals 28, thereby suppressing the deviation of the current and easily making the temperature distribution in the air conditioning device 20 uniform. Also, when the S4/S3 is larger than 2.00, the above effect (effect of suppressing the local heat generation due to the deviation of the power) can be obtained, while the flow of the air is obstructed by the intermediate material, so that the contact area of the functional material with the air decreases, making it difficult to obtain sufficient performance of the functional material. Further, when the S4/S3 is less than 0.50, it is difficult to obtain the above effect (the effect of suppressing the local heat generation due to the deviation of the power). From the viewpoint of stably ensuring the above effects, the S4/S3 is more preferably 0.50 to 1.20, and still more preferably 0.80 to 1.20.

The intermediate material is a member for increasing a degree of structural freedom in the connection between the pair of electrodes 26a, 26b and the terminals 28.

The intermediate material may be made of non-limiting materials, and it may be the same as the material of the terminal 28 as described above. Moreover, the material of the intermediate material may be different from that of the terminal 28 as described above. In this case, the intermediate material can be made of a solder, a brazing material, a conductive adhesive, or the like.

The size and shape of the intermediate material are not particularly limited. For example, the intermediate material can be provided over the whole of the pair of electrodes 26a, 26b on the outer peripheral wall 22. Further, the intermediate material may be provided on a part of the pair of electrodes 26a, 26b on the outer peripheral wall 22, or may be provided so as to extend toward an outer side than the outer edge of each of the pair of electrodes 26a, 26b on the outer peripheral wall 22. Furthermore, the intermediate material may be provided on a part of the pair of electrodes 26a, 26b on the partition walls 25, or may be provided so as to block a part of the cells 24.

The thickness of the intermediate material is not particularly limited, and it may be approximately the same as the thickness of the terminal 28, for example.

The method of connecting the intermediate material to the terminals 28 and the pair of electrodes 26a, 26b is not particularly limited as long as they are electrically connected, and they may be connected by, for example, diffusion bonding, mechanical pressing mechanism, welding, or the like.

### (2-4. Functional Material-Containing Layer 27)

The functional material-containing layer 27 can be provided on the surfaces of the partition walls 25 (in the case of the outermost cells 24, the partition walls 25 that define the outermost cells 24 and the outer peripheral wall 22). By thus providing the functional material-containing layer 27, the functional material can be easily heated during regeneration, so that the functional material can regenerate its desired function.

The functional material contained in the functional material-containing layer 27 is not particularly limited as long as it is a material that can exhibit a desired function, and examples that can be used herein include adsorbents, catalysts, and the like. The adsorbent preferably has a function of adsorbing one or more components selected from components to be removed in the air, such as water vapor, carbon dioxide, and volatile components. Also, the use of the catalyst can purify the components to be removed. Furthermore, the adsorbent and the catalyst may be used together for the purpose of enhancing the function of the absorbent to capture the components to be removed.

The adsorbent preferably has a function that can adsorb the components to be removed, such as water vapor, carbon dioxide and volatile components at −20 to 40° C. and release them at an elevated temperature of 60° C. or more. Examples of the adsorbent having such functions include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The catalyst preferably has a function capable of promoting the oxidation-reduction reaction. The catalysts having such functions include metal catalysts such as Pt, Pd and Ag, and oxide catalysts such as CeO₂ and ZrO₂. The catalyst may be used alone, or in combination with two or more types.

The volatile components contained in the air in the vehicle interior include, for example, volatile organic compounds (VOCs), and odor components other than the VOCs Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the functional material-containing layer 27 may be determined according to the size of the cells 24, and is not particularly limited. For example, the thickness of the functional material-containing layer 27 is preferably 20 μm or more, and more preferably 25 μm or more, and even more preferably 30 μm or more, from the viewpoint of ensuring sufficient contact with air. On the other hand, the thickness of the functional material-containing layer 27 is preferably 400 μm or less, and more preferably 380 μm or less, and even more preferably 350 μm or less, from the viewpoint of suppressing separation of the functional material-containing layer 27 from the partition walls 25 and the outer peripheral wall 22.

The thickness of the functional material-containing layer 27 is measured using the following procedure. Any cross section parallel to the flow path direction of the honeycomb structure 21 is cut out, and a cross-sectional image at magnifications of about 50 is acquired using a scanning electron microscope or the like. Also, this cross section is made to pass through the center of gravity position in the cross section orthogonal to the flow path of the honeycomb structure 21. The thickness of each functional material-containing layer 27 visually recognized from the cross-sectional image is calculated by dividing the cross-sectional area by the length of the cells 24 in the flow path direction. This calculation is performed for all the functional material-containing layers 27 visually recognized from the cross-sectional image, and an average value thereof is determined to be the thickness of the functional material-containing layer 27.

From the viewpoint of exerting a desired function in the air conditioning device 20, an amount of the functional material-containing layer 27 is preferably 50 to 500 g/L, and more preferably 100 to 400 g/L, and even more preferably 150 to 350 g/L, based on the volume of the honeycomb structure 21. It should be noted that the volume of the honeycomb structure 21 is a value determined by the external dimensions of the honeycomb structure 21.

### (2-5. Method for Producing Air Conditioning Device 20)

The method for producing the air conditioning device 20 according to the embodiment of the present invention is not particularly limited, and it can be performed according to a known method. Hereinafter, the method for producing the air conditioning device 20 according to an embodiment of the present invention will be illustratively described.

A method for producing the honeycomb structure 21 forming the air conditioning device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body(g/cm³)/true density of entire ceramic raw material(g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 21 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 21 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 21.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure 21 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 26a, 26b is formed on the honeycomb structure 21 thus obtained. The pair of electrodes 26a, 26b can be formed by metal deposition methods such as sputtering, vapor deposition, electrolytic deposition, and chemical deposition. Further, the pair of electrodes 26a, 26b can also be formed by applying an electrode paste and then baking it. Furthermore, the pair of electrodes 26a, 26b can also be formed by thermal spraying. The pair of electrodes 26a, 26b may be composed of a single layer, but may also be composed of a plurality of electrode layers having different compositions. A typical method for forming the pair of electrodes 26a, 26b will be described below.

First, an electrode slurry containing an electrode material, an organic binder, and a dispersion medium is prepared, and the first end face 23a or the second end face 23b of the honeycomb structure 21 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 21 is removed by blowing and wiping. The slurry can be then dried to form the pair of electrodes 26a, 26b on the first end face 23a or the second end face 23b of the honeycomb structure 21. The drying can be performed while heating the heater element to a temperature of about 120 to 600° C., for example. Although a series of steps of coating, slurry removal, and drying may be performed only once, the steps can be repeated multiple times to provide the pair of electrodes 26a, 26b having desired thicknesses.

The terminals 28 are then disposed at predetermined positions of the pair of electrodes 26a, 26b, and the pair of electrodes 26a, 26b and the terminals 28 are connected to each other. As a method of connecting the pair of electrodes 26a, 26b to the terminals 28, the method described above can be used.

It should be noted that the terminals 28 may be disposed after forming a functional material-containing layer 27 described below.

The functional material-containing layer 27 is then formed on the surface of each of the partition walls 25 and the like of the honeycomb structure 21.

Although the method for forming the functional material-containing layer 27 is not particularly limited, it can be formed, for example, by the following steps. The honeycomb structure 21 is immersed in a slurry containing a functional material, an organic binder, and a dispersion medium for a predetermined period of time, and an excess slurry on the end faces and the outer periphery of the honeycomb structure 21 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the functional material-containing layer 27 on the surfaces of the partition walls 25. The drying can be performed while heating the honeycomb structure 21 to a temperature of about 120 to 600° C., for example. Although a series of steps of immersion, slurry removal, and drying may be performed only once, the steps can be repeated multiple times to provide the functional material-containing layer 27 having the desired thickness on the surface of each of the partition walls 25 and the like.

### (3. Control Unit 30)

The control unit 30 is a portion for controlling the air conditioning device 20 and is electrically connected to the air conditioning device 20. The control unit 30 can adjust the heating state of the honeycomb structure 21 by controlling a power source (not shown) such as a battery for applying voltage to the pair of electrodes 26a, 26b of the air conditioning device 20.

Further, the control unit 30 is also electrically connected to a switching valve 40, and can also control the switching valve 40. Further, the control unit 30 can also be electrically connected to a ventilator (not shown) to control the ventilator.

The control unit 30 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside. The control unit 30 calculates the resistance from the magnitude of the current and voltage flowing through the honeycomb structure 21, and determines whether or not to apply voltage to the pair of electrodes 26a, 26b based on the results.

In the mode of capturing (removing) the components to be removed contained in the air in the vehicle interior, the control unit 30 switches the switching valve 40 so that air flows through the first path 10a, and starts the ventilator. At this time, the air conditioning device 20 is not heated. Such a control allows the air in the vehicle interior to be purified or dehumidified, or the like. Specifically, the air from the vehicle interior flows in the air conditioning device 20 through the air conditioning duct 10, and the components to be removed contained in the air in the vehicle interior are captured by the functional material-containing layer 27 while the air passes through the air conditioning device 20. The purified or dehumidified air flowing out from the air conditioning device 20 is returned to the vehicle interior through the first path 10a.

In the mode of regenerating the functional material-containing layer 27, the control unit 30 switches the switching valve 40 so that the air flows through the second path 10b, applies voltage to the pair of electrodes 26a, 26b, and starts the ventilator. Such a control allows the functional material-containing layer 27 to be regenerated. Specifically, the air from the vehicle interior allows the components to be removed, which are captured in the functional material containing layer 27, to be released or reacted while the air flows in the air conditioning device 20 through the air conditioning duct 10 and passes through the air conditioning device 20. Then, the air containing the component to be removed that has flowed out from the air conditioning device 20 is discharged to the vehicle exterior through the second path 10b. It should be noted that the timing for stopping the voltage application to the pair of electrodes 26a, 26b is as described above.

In the mode of regenerating the functional material-containing layer 27, the functional material is preferably heated at a temperature higher than the desorbing temperature depending on the type of the functional material in order to promote the desorbing of the component to be removed that is captured by the functional material. For example, when an adsorbent is used as the functional material, it is preferable to heat at least a part of the functional material, preferably all of it, at 70 to 150° C., more preferably 80 to 140° C., and even more preferably 90 to 130° C.

From the viewpoint of stably performing the above control, it is desirable that the air conditioning device 20 be placed at a position close to the vehicle interior. Therefore, from the viewpoint of preventing electric shock and the like, it is preferable that the driving voltage of the air conditioning device 20 is 60V or less. Since the honeycomb structure 21 used in the air conditioning device 20 has a low electrical resistance at room temperature, the honeycomb structure 21 can be heated at the low driving voltage. It should be noted that the lower limit of the driving voltage is not particularly limited, but it may preferably be 10 V or more. If the driving voltage is less than 10V, the current during heating the honeycomb structure 21 becomes large, so that the conductor wire should be thick.

### <Method for Regenerating Air Conditioning Device>

The method for regenerating an air conditioning device according to an embodiment of the present invention can be suitably used for regenerating an air conditioning device in a vehicle.

As shown in FIGS. 2A and 2B, the air conditioning device 20 used in the method for regenerating the air conditioning device according to the embodiment of the present invention includes: a honeycomb structure 21 having an outer peripheral wall 22, and partition walls 25 disposed on an inner side of the outer peripheral wall 22, the partition walls 25 defining a plurality of cells 24 each extending from a first end face 23a to a second end face 23b to form a flow path, at least the partition walls 25 being made of a material having a PTC property; a pair of electrodes 26a, 26b provided on the honeycomb structure 21; and a functional material-containing layer 27 formed on a surface of each of the partition walls 25. The air conditioning device 20 may further include terminals 28 connected to the pair of electrodes 26a, 26b.

It should be noted that the details of the air conditioning device 20 are as described above, so the description thereof will be omitted.

When regenerating the air conditioning device 20, a voltage is applied to the pair of electrodes 26a, 26b to heat the honeycomb structure 21. As a result, the component to be removed that is captured in the functional material-containing layer 27 is desorbed from or reacted with the functional material-containing layer 27 to release them, so that the functional material-containing layer 27 is regenerated.

Further, the voltage application to the pair of electrodes 26a, 26b is stopped at the stage of reaching the Curie point of the honeycomb structure 21. By stopping the voltage application at such a stage, it is possible to prevent excessive power from being applied to regenerate the functional material-containing layer 27. Furthermore, since excessive heat generation in the functional material-containing layer 27 is suppressed, any thermal deterioration of the functional material-containing layer 27 can also be suppressed.

The stage of reaching the Curie point of the honeycomb structure 21 is preferably determined by calculating the resistance ratio of a resistance over time during voltage application to an initial resistance of the honeycomb structure 21. By thus determining the stage of reaching the Curie point of the honeycomb structure 21, it is not necessary to determine the Curie point of the honeycomb structure 21 in advance and then continuously measure the temperature of the honeycomb structure 21. Therefore, the voltage application state can be easily controlled by the control unit 30.

The voltage application to the pair of electrodes 26a, 26b is preferably stopped at the stage where after calculating resistance ratio variation amount per a predetermined time and confirming the maximum value of the resistance ratio variation amount, the resistance ratio variation amount becomes ⅔ or less, and more preferably ½ or less, of the maximum value. With such a configuration, the voltage application to the pair of electrodes 26a, 26b can be stably stopped at the stage of reaching the Curie point of the honeycomb structure 21.

The predetermined time for calculating the resistance ratio variation amount is not particularly limited, but it may preferably be 5 to 25 seconds. In such a range, the amount of variation in the resistance ratio can be reliably recognized while minimizing the frequency of resistance measurement.

### DESCRIPTION OF REFERENCE NUMERALS

10 air conditioning duct
10a first path
10b second path
20 air conditioning device
21 honeycomb structure
22 outer peripheral wall
23a first end face
23b second end face
24 cell
25 partition wall
26a, 26b pair of electrodes
27 functional material-containing layer
28 terminal
30 control unit
40 switching valve
100 vehicle air conditioning system

1. A vehicle air conditioning system, comprising:
an air conditioning duct through which air can flow;
an air conditioning device disposed in the air conditioning duct; and
a control unit for controlling the air conditioning device,
wherein the air conditioning device comprises: a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a functional material-containing layer formed on a surface of each of the partition walls, and
wherein the control unit executes a voltage application to the pair of electrodes to heat the honeycomb structure and regenerate the functional material-containing layer, and stops the voltage application to the pair of electrodes at a stage of reaching the Curie point of the honeycomb structure.

2. The vehicle air conditioning system according to claim 1, wherein the control unit determines the stage of reaching the Curie point of the honeycomb structure by calculating a resistance ratio of a resistance over time during the voltage application to an initial resistance of the honeycomb structure.

3. The vehicle air conditioning system according to claim 2, wherein the control unit calculates an amount of variation in the resistance ratio per a predetermined time, checks a maximum value of the amount of variation, and then stops the voltage application to the pair of electrodes at the stage where the amount of variation becomes ⅔ or less of the maximum value of the amount of variation.

4. The vehicle air conditioning system according to claim 3, wherein the amount of variation at which the voltage application is stopped is less than or equal to ½ of the maximum value of the amount of variation.

5. The vehicle air conditioning system according to claim 3, wherein the predetermined time is 5 to 25 seconds.

6. The vehicle air conditioning system according to claim 1, wherein the air conditioning device further comprises terminals connected to the pair of electrodes.

7. The vehicle air conditioning system according to claim 1, wherein the material having the PTC property is made of a material comprising barium titanate as a main component, the material being substantially free of lead.

8. The vehicle air conditioning system according to claim 1, wherein the material having the PTC property has a volume resistivity of 0.5 to 30 Ω·cm at 25° C.

9. The vehicle air conditioning system according to claim 1, wherein the honeycomb structure has a thickness of the partition wall of 0.300 mm or less, a cell density of 100 cells/cm² or less, and a cell pitch of 1.0 mm or more.

10. The vehicle air conditioning system according to claim 1, wherein the honeycomb structure has a thickness of the partition wall of 0.08 to 0.36 mm, a cell density of 2.54 to 140 cells/cm², and an opening ratio of the cells of 0.70 or more.

11. The vehicle air conditioning system according to claim 1, wherein the functional material-containing layer comprises a functional material having a function of adsorbing one or more selected from water vapor, carbon dioxide, and volatile components.

12. The vehicle air conditioning system according to claim 11, wherein the functional material-containing layer comprises a catalyst.

13. A method for regeneration of an air conditioning device, the air conditioning device comprising: a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the honeycomb structure; and a functional material-containing layer formed on a surface of each of the partition walls,
wherein the method comprises executing a voltage application to the pair of electrodes to heat the honeycomb structure and to regenerate the functional material-containing layer, and stopping the voltage application to the pair of electrodes at a state of reaching a Curie point of the honeycomb structure.

14. The method for regenerating an air conditioning device according to claim 13, wherein the stage of reaching the Curie point of the honeycomb structure is determined by calculating a resistance ratio of a resistance over time during the voltage application to an initial resistance of the honeycomb structure.

15. The method for regenerating an air conditioning device according to claim 14, wherein an amount of variation in the resistance ratio per a predetermined time is calculated, a maximum value of the amount of variation is checked, and then the voltage application to the pair of electrodes is stopped at a stage where the amount of variation becomes ⅔ or less of the maximum value of the amount of variation.

16. The method for regenerating an air conditioning device according to claim 15, wherein the amount of variation at which the voltage application is stopped is less than or equal to ½ of the maximum value of the amount of variation.

17. The method for regenerating an air conditioning device according to claim 15, wherein the predetermined time is 5 to 25 seconds.

18. The method for regenerating an air conditioning device according to claim 13, wherein the air conditioning device further comprises terminals connected to the pair of electrodes.
